(19) United States
(12) Patent Application Publication
(10) Pub. No.: US 2012/0279205 A1
(43) Pub. Date: Nov. 8, 2012

(54) INTERNAL COMBUSTION ENGINES

(76) Inventor: Nigel Alexander Buchanan, New Gilston (GB)

(21) Appl. No.: 13/391,201

(22) PCT Filed: Aug. 19, 2010
(86) PCT No.: PCT/GB10/01571

§ 371 Date: May 15, 2012

(30) Foreign Application Priority Data
Aug. 19, 2009 (GB) 0914521.0

(51) Int. Cl. F02D 15/04; G06F 17/00; F01N 3/02

(52) U.S. Cl. 60/281; 123/48 R; 60/320

(57) ABSTRACT

An internal combustion engine includes a chamber (12) and a flexible dividing member (18) secured to wall of the chamber and dividing the chamber into a first chamber portion (14) having a variable volume and a second chamber portion (16) having a variable volume. The engine has inlet valving (20, 22) to admit constituents of a combustible mixture into the first chamber portion for combustion therein to provide a pressure increase to cause flexing of the flexible dividing member to reduce the volume of the second chamber portion to force a liquid from the second chamber portion as an energy output of the chamber. The engine has input valving (98) to admit an aqueous fluid into the first chamber portion to provide an aqueous fluid supply in the first chamber portion to protect the flexible dividing member.

### FIELD OF THE INVENTION

The invention relates to internal combustion engines and particularly, but not exclusively, to internal combustion engines for powering automotive vehicles.

### BACKGROUND TO THE INVENTION

The reciprocating piston spark ignition engine is one known form of internal combustion engine used to power automotive vehicles. Reciprocating piston spark ignition engines comprise a number of pistons arranged to reciprocate in respective cylinders and each connected to a crankshaft. Each of the cylinders is provided with inlet valving for controlling the inflow of air and fuel, exhaust valving for controlling the exhaust of the products of combustion and a spark plug for igniting the air fuel mixture. Where the supply of fuel to the engine is controlled by a carburettor, the air and fuel are mixed in an intake manifold upstream of the cylinders and the inlet valving comprises an intake valve that controls the intake of the fuel-air mixture into the cylinder. If the fuel supply to the cylinders is by fuel injection, the inlet valving comprises two valves. One of the valves is a fuel injector and the other is an air intake valve. The fuel injector may be arranged to inject fuel directly into the cylinder or may inject it into an air intake duct just upstream of the air intake valve.

Typically, reciprocating spark ignition engines operate a four-stroke cycle. Each movement of a piston up or down its cylinder comprises one stroke of the four-stroke cycle. The four-stroke cycle consists of:
an induction stroke during which the inlet valving opens and air and fuel are taken into the engine as the piston moves towards the crankshaft;
a compression stroke during which the inlet and exhaust valving are closed and the air fuel mixture is compressed while the piston moves away from the crankshaft;
a power, or working, stroke during which the compressed mixture is ignited and the rapid expansion caused by combustion of the mixture forces the cylinder back towards the crankshaft; and
an exhaust stroke during which the exhaust valving is open and the exhaust gases are forced out of the cylinder as the piston moves away from the crankshaft again.

Some reciprocating piston spark ignition engines operate a two-stroke cycle, which is a variant of the four-stroke cycle. Such engines are usually of smaller capacity than four-stroke engines and in terms of passenger vehicles tend to be used for two-wheeled vehicles. Two stroke engines use ports located along the side of the cylinder instead of valves. As the piston moves up and down the cylinder, the ports are covered and uncovered depending on where the piston is in the cylinder. In essence, in a two-stroke engine the induction and compression processes take place during the first stroke and the combustion and exhaust processes take place during the second stroke.

The reciprocating piston compression ignition internal combustion engine is another form of engine commonly used to power automotive vehicles. Reciprocating piston compression ignition engines use a fuel having a lower auto-ignition temperature than the fuels used by spark ignition engines and operate a modified version of the four-stroke cycle described above. Specifically, during the induction stroke air is drawn into the cylinder and that air is compressed to a high pressure and temperature during the compression stroke. Fuel is then injected directly into the cylinder (or into a mixing chamber that leads into the cylinder) and combustion takes place as the fuel mixes with the high temperature compressed air in the cylinder. Historically, reciprocating piston compression ignition engines were considered noisy and slow and in the automotive field were used mainly for trucks and other commercial vehicles such as buses. However in more recent times, high performance reciprocating piston compression ignition engines have been developed and now reciprocating piston compression ignition engines are commonly used in small passenger vehicles such as saloon cars (sedans).

The Wankel engine is another form of spark ignition engine that has been used to power automotive vehicles. The Wankel engine employs a four ‘stroke’ cycle similar to the four-stroke cycle employed by the reciprocating piston spark ignition internal combustion engine. However, instead of reciprocating pistons, the Wankel engine has a roughly triangular rotor that is mounted on an eccentric shaft for rotation in an approximately oval (epitrochoid-shaped) chamber. The ‘four strokes’ take place in the spaces between the rotor and the chamber wall.

A common feature of these known internal combustion engines is that the fuel air mixture is input to a chamber in which it is combusted so that the rapid expansion of the mixture caused by the combustion acts directly on a body (piston or rotor) that is connected to an output shaft so as to cause rotation of the shaft; the output of the engine being the rotation of the shaft.

### SUMMARY OF THE INVENTION

The invention provides an internal combustion engine comprising a chamber, a flexible dividing member secured in said chamber to divide said chamber into a first chamber portion having a variable volume and a second chamber portion having a variable volume, inlet valving operable to admit constituents of a combustible mixture into said first chamber portion for combustion therein to provide a pressure increase to cause flexing of said flexible dividing member to reduce said volume of said second chamber portion to force a liquid from said second chamber portion as an energy output of said chamber and input valving to admit an aqueous fluid into said first chamber portion to provide a supply of aqueous fluid in said first chamber portion to protect said flexible dividing member.

The invention also includes a method of operating an internal combustion engine that comprises a chamber that is divided into a first chamber portion and a second chamber portion by a flexible dividing member secured within said chamber, said first and second chamber portions each having a volume that is variable by flexing movement of said flexible dividing member, said method comprising providing an aqueous liquid covering on a face of said flexible dividing member that faces into said first chamber portion, combusting a combustible mixture in said first chamber portion to provide a pressure increase that causes said flexible dividing member to move towards said second chamber portion to reduce said volume of said second chamber portion to force a liquid from said second chamber portion as an energy output of said chamber.

### BRIEF DESCRIPTION OF THE DRAWINGS

In order that the invention may be well understood, some embodiments thereof, which are given by way of example only, will now be described with reference to the drawings in which:

FIG. 1 is a schematic illustration of a single cylinder internal combustion engine shown at commencement of an operating cycle;

FIG. 2 shows the internal combustion engine of FIG. 1 at the end of a compression phase of the operating cycle;

FIG. 3 is an enlarge cross-sectional view of a portion of a flexible dividing member of the internal combustion member of FIG. 1;

FIG. 4 is a schematic representation of an embodiment of a control unit for the internal combustion engine of FIG. 1;

FIG. 5 is a schematic illustration of a modification of the single cylinder internal combustion engine shown in FIG. 1; and

FIG. 6 is a schematic illustration of a multi-cylinder internal combustion engine connected to a motor vehicle drive train.

### DETAILED DESCRIPTION OF THE ILLUSTRATED EMBODIMENTS

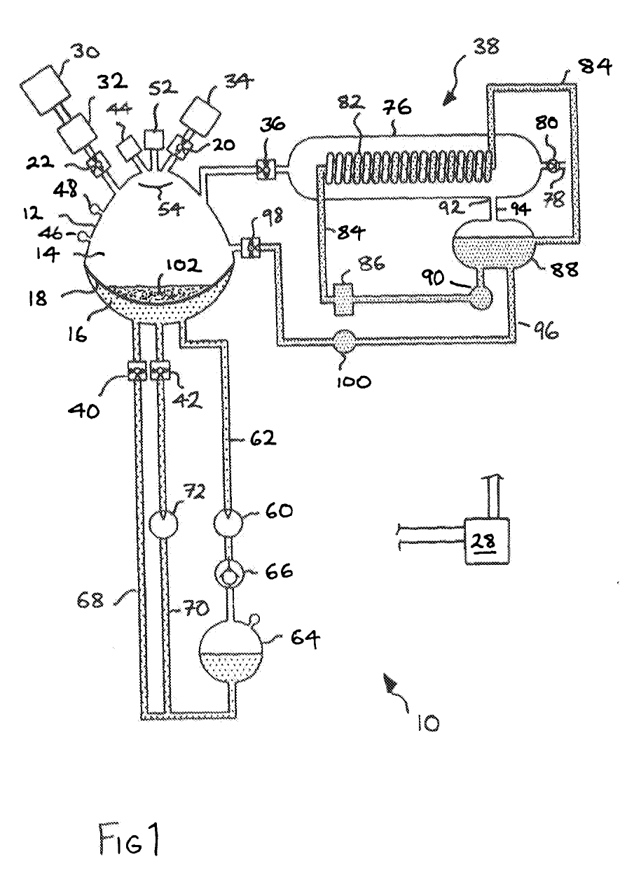

Referring to FIG. 1, an internal combustion engine 10 comprises a body 12 that defines a chamber that is divided into a first chamber portion 14 and a second chamber portion 16 by a flexible dividing member 18. The periphery of the dividing member 18 is secured to a wall of the body 12 such that movement of the dividing member relative to the body is limited to flexure of the dividing member. Although not essential, in the illustrated embodiment the body 12 has generally circular cross-sections and the flexible dividing member 18 has a cross-section complementary to the cross-section of the region of the body 12 to which it is secured.

The internal combustion engine 10 is provided with inlet valving for controllably admitting constituents of a combustible mixture into the first chamber portion 14.

Although not essential, in the illustrated embodiment, the inlet valving comprises an air inlet valve 20 for controlling the flow of aspirant air into the first chamber portion 14 and a fuel injection valve 22 through which fuel is injected directly into the first chamber portion. The air inlet valve 20 may be an electrically actuated normally closed solenoid valve and the fuel injection valve 22 may be any suitable known fuel injection valve. Operation of the air intake valve 20 and fuel injector 22 is controlled by a control system that includes a microprocessor based control unit 28. The respective connections between the control unit 28 and the air intake valve 20 and fuel injector 22 have been omitted from the drawings for the sake of the overall clarity of the drawings.

The fuel injector 22 is connected to a fuel reservoir 30 via a fuel pump 32.

The air intake valve 24 is in flow communication with an air intake system 34. The air intake system 34 may comprise an air filter(s) and suitable ducting and/or an air intake manifold(s) through which aspirant air is supplied to the cylinder 12 via the air intake valve. Although not essential, the intake air may be pressurised by turbo charging or supercharging. Turbo charging and supercharging are techniques that will be familiar to those in skilled in the art and so will not be described in detail herein.

As one alternative to separate valves to control the admission of the air and fuel into the first chamber portion 14, the fuel and air may be mixed in a manifold upstream of the first chamber portion and admitted to the first chamber portion via a single valve.

The internal combustion engine 10 also includes exhaust valving 36 associated with the body 12. The exhaust valving 36 may take the form of a normally closed solenoid actuated exhaust valve 36. Operation of the exhaust valve 36 is controlled by the control unit 28. The control unit 28 provides signals to the exhaust valve 36 to cause selective opening of the valve to allow the products of combustion (exhaust gases) to be exhausted from the body 12 to an exhaust system 38. The exhaust system 38 is described in more detail below.

The internal combustion engine 10 also includes fluid admission control valving which may take the form of a normally closed solenoid actuated fluid admission control valve 40 and a normally closed solenoid actuated start up admission control valve 42. Both fluid admission control valves 40, 42 are arranged to control the admission to the second chamber portion of a liquid that is to be energised by a combustion process and form an energy output of the internal combustion engine 10. Operation of the fluid admission control valves 40, 42 is controlled by the control unit 28.

In addition to the control unit 28, a control system for the internal combustion engine 10 includes a sensor 44 that is arranged to output signals indicative of the pressure within the body 12. Any suitable sensor may be used. Since the temperature in the body 12 will closely follow the pressure, the sensor may be a temperature sensor 44 such as a thermocouple with its temperature sensing portion disposed within the first chamber portion 14. It will be appreciated that for the purposes of controlling operation of the internal combustion engine, at least during some phases of its operation, a temperature sensor used to sense the temperature in the body 12 needs to be highly responsive to temperature changes taking place within the cylinder. One example of a suitable alternative to a thermocouple is an optical sensor such as an infrared temperature sensor. If an optical sensor is used, the body 12 would have to be provided with a suitably located translucent window (not shown). Another alternative would be a high temperature embedded photodiode such as is disclosed in U.S. Pat. No. 5,659,133 (the content of which is incorporated herein by reference).

The control system for the internal combustion engine 10 also includes sensors 46, 48 to sense the presence of an aqueous liquid in the first chamber portion 14. The sensors 46, 48 are connected with the control unit 28 to supply signals to the control unit. The sensors may be optical or contact sensors.

The internal combustion engine 10 also includes a combustion initiator, which in this embodiment takes the form of a spark plug 52. The spark plug 52 operates under control of the control unit 28 and is connected with a suitable voltage supply system, which may include a coil, from which a voltage for the spark can be drawn. Spark plug technology will be familiar to those skilled in the art and so will not be described in detail herein.

A baffle 54 is provided in the first chamber portion 14 to protect the spark plug 52 from splashing by a liquid carried on the dividing member 18.

The body 12 is connected to a drive unit 60 by outlet ducting 62. The ducting 62 extends from an aperture that opens into the second chamber portion 16 such that energised liquid output from the second chamber portion can flow into the drive unit 60. The drive unit 60 comprises a pump, turbine or other suitable device for converting kinetic energy stored in the liquid into a force that can, for example, be used to turn the wheels of a vehicle or power a generator.

Downstream from the drive unit 60 there is a reservoir 64 to receive liquid from the drive unit 60 from which energy has been extracted. A one-way valve 66 is provided between the drive unit 60 and reservoir 64 to prevent back flow of liquid from the reservoir. A first ducting system 68 extends downstream from the reservoir 64 to the fluid admission control valve 40 such that when the valve is opened, the liquid can pass from the reservoir into the second chamber portion 16. A second ducting system 70 extends from the reservoir 64 to the start up fluid admission control valve 42. A start up pump 72 is provided in the second ducting system 70 between the reservoir 64 and the start up fluid admission control valve 42 to raise the pressure of the liquid delivered from the reservoir to the second chamber portion 16. The start up pump 72 operates in response to signals received from the control unit 28.

The exhaust system 38 comprises a receptacle 76, which has an upstream side connected with the exhaust valve 36 and a downstream side that includes an outlet 78 provided with an exhaust outlet valve 80. The exhaust outlet valve 80 may be a normally closed electrically actuated solenoid valve that is controlled by the control unit 28.

The receptacle 76 contains a heat exchange coil 82 that extends in a lengthways direction of the receptacle. The ends of the heat exchange coil 82 are connected with ducting 84 to form a part of a closed circuit cooling system. The cooling system includes a radiator 86 and may optionally include other cooling devices such as a refrigeration unit (not shown). A reservoir 88 is connected into the ducting 84 to provide a supply of liquid coolant, which in this embodiment is an aqueous fluid. A pump 90 is provided in the cooling circuit to pump the coolant around the circuit.

The receptacle 76 has an opening 92 connected with the reservoir 88 by ducting 94. The arrangement of the opening 86 and ducting 90 is such that condensate that pools in the bottom of the receptacle 76 can flow into the reservoir 88. Portions of the wall of the receptacle 76 adjacent the opening 92 may be configured to encourage the condensate to flow towards the opening. A one-way valve (not shown) is provided in the ducting 94 to prevent backflow of liquid into the receptacle 76.

The reservoir 88 is additionally connected with the first chamber portion 14 of the body 12 by means of ducting 96. An admission valve 98 is provided in the ducting 96 to control the admission of aqueous liquid from the reservoir 88 into the first chamber portion 14. The admission valve 98 may be a normally closed solenoid actuated valve that is controlled by signals issued by the control unit 28. A pump 100 is provided in the ducting to raise the pressure of the aqueous liquid that is delivered into the first chamber portion 14. The pump 100 may be controlled by signals issued by the control unit 28.

As illustrated in FIG. 3, the flexible dividing member 18 may be provided with a surface 104 that is provided with pockets, or depressions, 106. In the illustrated embodiment, the pockets 106 are semi-circular in cross-section and disposed at irregular intervals across the entire surface 104. However, this is not essential. In principle the pockets 106 may be of any shape, regular or irregular. Also, the pockets 106 may be disposed at regular intervals across the surface 104. For some embodiments it may desirable for the pockets to be deeper and/or more densely located in the central region of the flexible dividing member 18 than at its periphery. The flexible dividing member 18 is arranged such that the surface 104 faces into and partially defines the first chamber portion 14. The pockets 106 will tend to retain the aqueous fluid supplied via the admission valve 98 to protect the flexible dividing member 18 from the full heat of combustion.

In the description of the operation of the internal combustion engine 10 that follows, the liquid to be energised and output to the drive device 60 is an oil and the fuel supplied through the fuel injector 22 is petrol (gasoline). However, it is to be understood that liquids other than oil can be used as the working fluid and fuels other than petrol can be used.

FIG. 1 shows the internal combustion engine 10 at the commencement of a new operating cycle. At this stage, the first chamber portion 14 is at its maximum volume and the second chamber portion 16 is at its minimum volume. The exhaust valve 36 and admission valve 98 are closed and there is a pool 102 of aqueous fluid held on the surface 104 of the flexible dividing member 18 that faces into the first chamber portion. The air inlet valve 20 is then opened in response to a signal from the control unit 28 to admit aspirant air to the first chamber portion 14. The pressure in the first chamber portion 14 is sub-atmospheric so that the air is sucked into the first chamber portion 14 through the air inlet valve. As indicated above, the aspirant air may be pressurised, for example by supercharging, to force air into the first chamber portion.

The fuel injector 22 may be opened at the same time as the air inlet valve 20 so that the fuel and air mix as they are admitted to the first chamber portion 14. Alternatively, the fuel may be admitted to the first chamber portion at a later stage after the air has been pressurised by flexing of the flexible dividing member 18. The control unit 28 issues a signal to close the air inlet valve 20 when signals from the sensor 44 indicate a predetermined pressure in the first chamber portion 14. Alternatively, the air inlet valve 20 is closed at the end of a predetermined time interval during which it has been open.

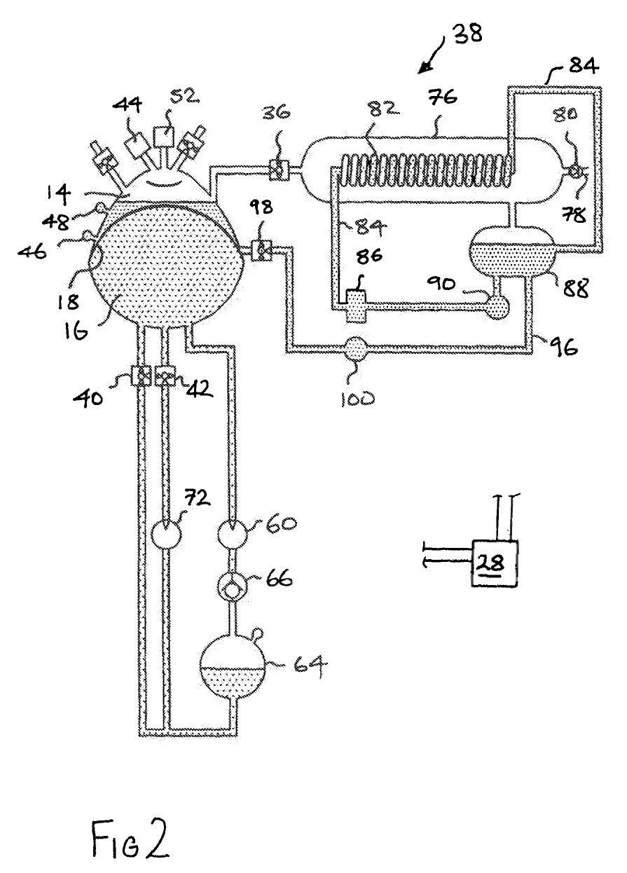

Referring to FIG. 2, the control unit 28 then issues a signal to open one of the admission control valves 40, 42. During engine start up, it is the admission control valve 42 that is opened to admit oil to the second chamber portion that has been pressurised by the pump 72. If the internal combustion engine 10 is already running, the admission control valve 40 is opened to admit pressurised oil from the reservoir 64. The inflowing oil pushes against the flexible dividing member 18 causing it to flex in the direction of the first chamber portion 14 such that the volume of the second chamber portion 16 increases and the volume of the first chamber portion 14 decreases. The decrease in volume of the first chamber portion 14 compresses the air (or air fuel mixture) in the first chamber portion. The control unit 28 monitors the pressure in the first chamber portion 14 by means of signals received from the sensor 44 and closes the admission control valve that is open when a desired pressure is reached (for example when a compression ratio of 12:1 is achieved). If the oil is supplied from the reservoir 64 via the admission control valve 40 and there is insufficient pressure in the reservoir to achieve the desired compression ratio, the control unit 28 may signal the admission control valve 42 to open and cause the pump 72 to operate to boost the pressure in first chamber portion 14.

When the desired pressure in the first chamber portion 14 is achieved, any open admission control valve 40, 42 is signalled to close and a signal is issued to cause the spark plug 52 to discharge. Operation of the spark plug 52 initiates combustion of the combustible mixture in the first chamber portion 14. Combustion of the combustible mixture produces a rapid increase in pressure in the first chamber portion 14 that forces the flexible dividing member 18 to flex in the direction of the second chamber portion 16 and thereby cause a rapid reduction in the volume of the second chamber portion. This forces oil to flow from the second chamber portion at high pressure and velocity into the ducting 62. Energy from the high pressure and velocity oil flowing from the ducting 62 into the drive unit 60 is converted into an output force, which may, for example, be a torque or a mono or bi-directional (reciprocating) translational force.

As shown in FIG. 2, when the flexible dividing member 18 is flexed towards the first chamber portion 14 during compression of the air in the first chamber portion, the pool 102 of aqueous fluid forms a layer that covers the entire surface 104 of the flexible dividing member that faces into the first chamber portion. This protects the flexible dividing member 18 from heat damage during the combustion event. The rapid acceleration of the flexible dividing member 18 in response to the pressure increase caused by combustion of the combustible mixture causes a portion of the aqueous fluid to separate from the layer of aqueous fluid to provide droplets of aqueous fluid within the combusting fuel air mixture. The mist of droplets in the midst of the combusting gases improves the combustion process and may result in a hydrogen separation process (steam reformation and in some cases dissociation of the aqueous fluid droplets) to produce hydrogen that is combusted in the first chamber portion 14.

Steam reformation processes take place at temperatures around 700 to 1000° C. Although the mist of droplets will have some cooling effect on the combustion gases, by controlling the amount of aqueous fluid present on the surface 104 of the flexible dividing member 18 temperatures in the region of 1000 to 2000° C. or more can be maintained so that as the droplets vaporise in the midst of the fuel (hydrocarbon) rich combustion gases, steam reformation takes place causing the separation of hydrogen from the hydrocarbons. Since auto ignition of hydrogen takes place at temperatures of around 585° C., the hydrogen released from the fuel spontaneously combusts. This results in heightening of the pressure and temperature in the first chamber portion 14 so increasing the force driving flexible dividing member to force the oil from the second chamber portion 16. Burning of the hydrogen produced results in a rapid temperature increase in the first chamber portion that may result in further hydrogen separation in the first chamber portion 14. In order to promote steam reformation in the first chamber portion, the fuel air mixture may be formed such that it is fuel rich to provide an excess of hydrocarbons in the mixture from which the hydrogen is separated.

When the combustion process is complete, as indicated by pressure indicating signals from the sensor 44, the control unit 28 opens the exhaust valve 36. A partial vacuum is normally maintained in the receptacle 76 so that when the exhaust valve 36 opens, the products of combustion, which are still at a relatively high pressure, are sucked into the receptacle. The exhaust outlet valve 80 is opened to allow the exhaust gases sucked into the receptacle 76 to escape to atmosphere. When the pressure in the receptacle 76 reaches atmospheric pressure, or a pressure close to atmospheric, the control unit 28 issues a signal that causes the exhaust outlet valve 80 to close. The pressure in the receptacle 76 may be judged based on signals from the sensor 44 or by a sensor (not shown) arranged to directly detect the pressure in the receptacle.

The remaining exhaust gases in the receptacle 76 are rapidly cooled by the coolant flowing through the coil 82 causing water vapour in the exhaust gases to condense out and pool in the receptacle. It also causes a rapid pressure drop in the receptacle 76 producing a partial vacuum in both the first chamber portion 14 and receptacle. The vacuum level is proportional to the volume ratio of the first chamber portion and the receptacle. The volume of the receptacle is selected to be larger than that of the first chamber portion 14 to achieve a desired level of vacuum. When the pressure in the first chamber portion/receptacle is judged to be at a predetermined level, or at predetermined time after the opening of the exhaust valve 36, the exhaust valve is closed to isolate the vacuum in the receptacle. At this stage, the internal combustion engine 10 is returned to the condition shown in FIG. 1 ready for the commencement of a new operating cycle and there is a partial vacuum in the first chamber portion 14 to cause air to be sucked into the first chamber portion at the commencement of the next charging process and the partial vacuum is stored in the receptacle 76 to suck exhaust products from the first chamber portion at the commencement of the next exhaust process.

It will be appreciated that the aqueous fluid pool 102 is diminished during a combustion event. The control unit 28 is able to judge the aqueous liquid level during compression of the air in the first chamber portion 14 based on signals from the sensors 46, 48. If there is sufficient aqueous liquid on the flexible dividing member 18 the signals from the sensors will equalise, if not the signals will be different. If the level of aqueous liquid is judged to be too low, the control unit 28 will issue signals to cause the admission control valve 98 to open and the pump 100 to pump a desired amount of liquid from the reservoir 88 into the first chamber portion 14. Preferably, the arrangement is such that the detection is made sufficiently ahead of the level falling to a critical level to allow the input of aqueous fluid before the compression of the air in the first chamber portion 14. In this way the work output required from the pump 100 is reduced. As an alternative to supplying the aqueous fluid replenishment from the reservoir 88, a separate reservoir may be provided for this purpose.

Although not shown, a one-way valve may be provided in the ducting 62 upstream of the drive unit 60 to isolate the drive unit from the pressure in the second chamber portion 16 except when the pressure is raised above a predetermined level during a combustion event. Alternatively, another form of valve such as a normally closed electrically actuated solenoid valve could be used.

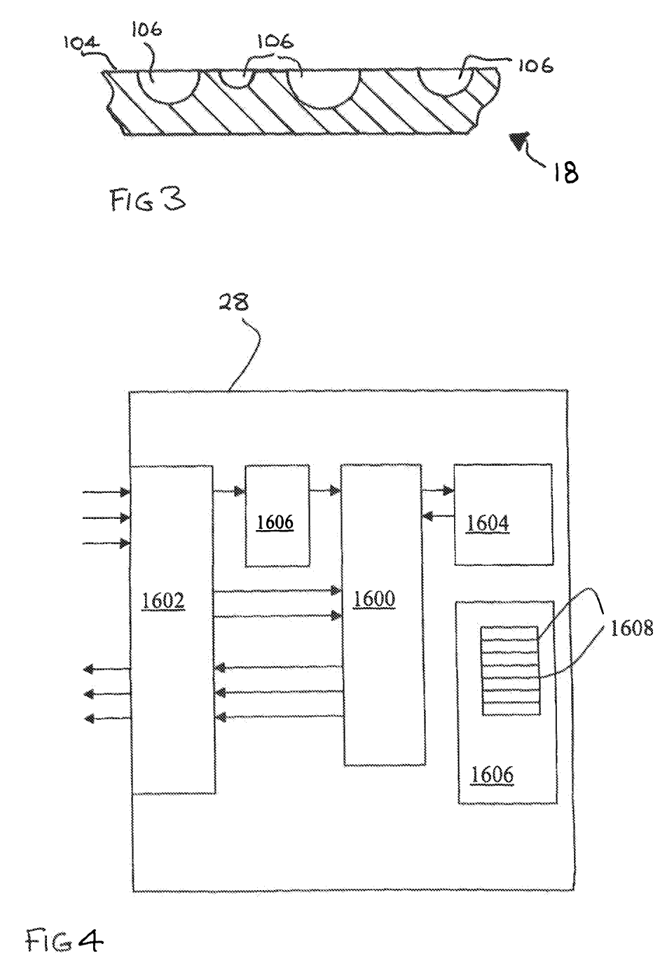

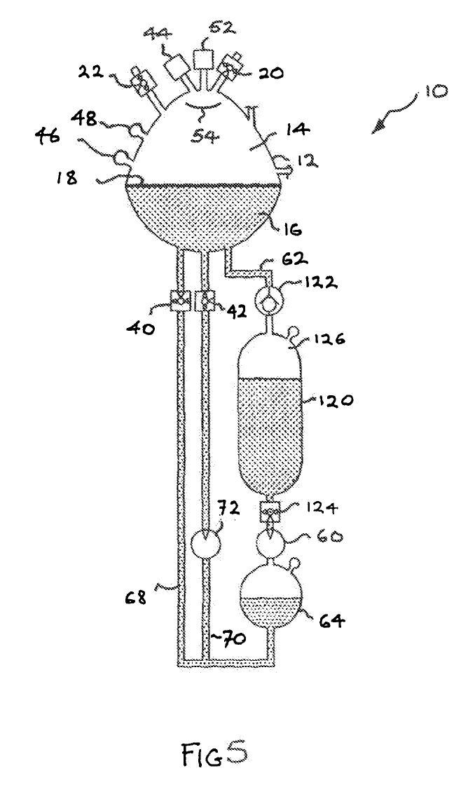

The control unit 28 and any associated ancillary equipment may take any suitable known form and may comprise components that will be well known to those skilled in the art. FIG. 4 is a schematic representation of a suitable control unit 28 that may comprise one or more a processors 1600 and signal conditioning components 1602. The signal conditioning components may for, for example, be used to amplify signals and/or convert analogue signals to digital and digital signals to analogue to permit the control unit to receive and use signals from the sensors and output usable signals to the valves and other components controlled by the control unit. The control unit 28 may additionally comprise one or more volatile memories, such as random access memory (RAM) 1604, to store data generated during operation of the internal combustion engine and circuitry 1606. The volatile memory(ies) may also be used in sampling incoming signals from one or more sensors to provide a usable input for the processor. The control unit 28 may additionally comprise one or more non-volatile data storage components, such as permanent memory 1606, which may be a read only memory (ROM). The non-volatile memory(ies) may be used to permanently store one or more control software portions 1608. Of course, for some applications, no permanent memory is required. For example, the control unit may be connected with a master computer in which the control algorithms are stored and which uploads them to a RAM in the control unit at start up of the control unit. Another alternative would be for the control unit to be slaved to a master control unit or computer. Yet another alternative would be for the control unit to comprise one or more hard wired control circuits.

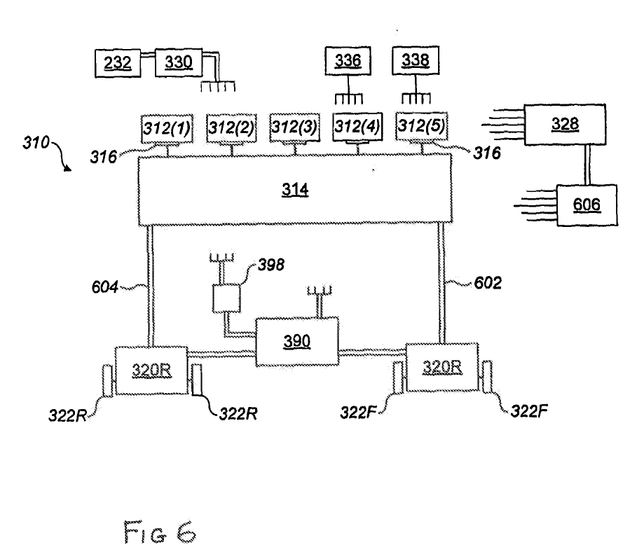

It will be appreciated that it is not essential that the oil output from the second chamber portion be supplied direct to the drive unit 60. Instead, as illustrated in FIG. 5, the internal combustion engine 10 may be provided with an output storage device 120 to receive the oil. The output storage device 120 is a receptacle positioned upstream of the drive unit 60. A one-way valve 122 (alternatively an electrically actuated valve) is provided in the ducting 62 between the output storage device 120 and the second chamber portion 16. The one-way valve is set to open when the pressure in the second chamber portion 16 exceeds a predetermined level to allow oil from the second chamber to flow into the output storage device 120. An electrically actuated valve 124 is provided between the output storage device 120 and the drive unit 60 to control the output of oil from the output storage device 120 to the drive unit so that the oil can be supplied to the drive unit on demand. The electrically actuated valve 124 may be controlled by the control unit 28 or by another control device associated with the internal combustion engine 10.

In use, when the flexible dividing member 18 is moved towards the second chamber portion 16 by pressure in the first chamber portion 14 generated by a combustion event, oil at high pressure and velocity is forced into the ducting 62. This causes the one-way valve 122 to open and allows the oil to flow into the output storage device 120. In the illustrated embodiment, the output storage device 120 is arranged such that the oil flows through a portion 126 of the output storage device that is maintained substantially free of liquid. As the output storage device 120 fills with oil, the gas in the portion 126 is compressed and thus stored energy in the manner of a spring.

When an output is required from the drive unit 60, the valve 124 is caused to open and oil will flow from the output storage device at high pressure and velocity under the influence of the compressed gas in the portion 126. The drive unit 60 converts some of the kinetic energy in the oil output from the output storage device into a required output force, such as a torque. For further information about the use of output storage devices attention is directed to the Applicants' earlier United Kingdom Patent Applications published as GB2 457 476, GB2 457 350 and GB2 457 351 the entire contents of which are incorporated herein by reference.

Although the internal combustion engine 10 is shown and described as a single cylinder engine, it may be formed as a multi-cylinder engine. FIG. 6 shows a multi-cylinder internal combustion engine 310. Each cylinder of the multi-cylinder internal combustion engine comprises a unit the same as, or similar to the cylinder formed by the body 12 in the internal combustion engine 10.

The multi-cylinder internal combustion engine 310 comprises five cylinders 312(1)-312(5) that are equipped and operate in the same way as the single cylinder of the engine 10. In this embodiment, the cylinders 312(1)-312(5) are each connected to a common air intake system 338 and exhaust system 336 and each is provided with a fuel injector (not shown) fed from a common fuel reservoir 330 via a common fuel pump 332. There is a reservoir 390 and start up pump 398 that feeds fluid from the reservoir to fluid admission control valves (not shown) corresponding to the valves 40, 42 shown in FIG. 1. While using common parts as described may be convenient for many engine configurations, it will be appreciated that in a multi-cylinder internal combustion engine, multiple air intake systems, exhaust systems, liquid return systems and/or fuel pumps and reservoirs can be used.

An output storage device 314 is connected to output valving 316 of each cylinder 312. In the illustrated embodiment, the output storage device 314 is an annular tubular structure. It is envisaged that using this ‘doughnut’ configuration will reduce pressure losses due to flow resistance. Although not show connected in this way, the cylinders 312(1) to 312(5) can be directly connected to the output storage device 314 so that the outflowing liquid can flow directly into the output storage device.

The output storage device 314 is connected to respective ducting systems 602, 604 that lead to a front wheel drive unit 320F and a rear wheel drive unit 320R. The drive units 320F, 320R convert the energy stored in the liquid received from the first reservoir 314 into a drive force to turn respective pairs of wheels 322F, 322R. Each of the drive units 320F, 320R returns the spent liquid to the reservoir 390.

In this embodiment, a control unit 328 controls the operation of the individual cylinders 312(1)-312(5) under the control of master engine control unit 606. The master engine control unit 606 receives input commands from a driver operated pedal and/or button(s) (not shown) and also controls the operation of the drive units 320F, 320R. Although not shown, it will be appreciated that a separate control unit can be provided to control the braking function of the drive units 320F, 320R. Such a control unit would be connected to the master control unit 606, which has overall responsibility for the control of the internal combustion engine 310.

In use, the individual cylinders 312(1)-312(5) of the multi-cylinder internal combustion engine 310 operate in the same way as the engine 10. The activity level of the individual cylinders 312(1)-312(5) is controlled based on the pressure in the output storage device 314. If the pressure in the output storage device 314 is above a predetermined level and the demand on the engine is low, the number of cylinders 312(1)-312(5) operating can be reduced proportionately.

It will be appreciated that the liquid output from the second chamber portion does not have to be oil and that any desired liquid, even water, can be used.

It will be appreciated that separating the liquid in the second chamber portion from the combustion events taking place in the first chamber portion makes it possible to use liquids in the second chamber portion, for example oil, that it would be at least undesirable to expose to the combusting gases.

It will be understood that engine manufacturers may supply the engine already filled with the working fluid (second fluid mass) or the working fluid may be added later by a vehicle manufacturer or, for non-vehicular applications, the manufacturer of the equipment with which the internal combustion engine is supplied, or by party who sells the engine or equipment in which it is included, or the end user.

It will be appreciated that the flexible dividing member may be diaphragm made of a suitably flexible material and secured around its entire periphery to an internal wall of a chamber, for example a circular section chamber, in which it is fitted.

The configuration of the flexible dividing member can be varied by the selection of the material from which it is made and the relative dimensions of the member and the portion area of the chamber in which it is fitted. Preferably, the configuration is such that at least when the flexible dividing member is at its position immediately prior to combustion and during combustion it is possible for the aqueous fluid to at least substantially cover the entire surface 104 of the flexible dividing member. It may be desirable for the flexible dividing member to be substantially planar when it a relaxed condition. Appropriate proportions and materials can readily be determined empirically.

In the illustrated embodiments, the flexible dividing member is shown secured directly to the wall of the body 12. This is not essential. The flexible dividing member may be fitted to a support, for example an annular support member, that is secured to the wall of the body 12.

The timing of the combustion event in the illustrated internal combustion engines is not as critical as in conventional reciprocating piston internal combustion engines. For example, if there is pre-ignition as a consequence of varying octane levels in the fuel, the rapid pressure increase in the engine cylinder(s) as combustion occurs will still cause the liquid outflow to be driven from the cylinder(s) in the same way as it would following a normal combustion event. Thus the potential damage to engine components and power losses that typically result when there is pre-ignition in a conventional reciprocating piston internal combustion engine are avoided, or at least reduced. This makes the engine particularly suitable for use with fuels that do not exhibit the same consistency of quality as the commonly used petroleum based fuels and, for example, makes the engines particularly suitable for use with alcohol based fuels such as ethanol, which can be produced from renewable sources.

It will be understood that the condition and proportions of the internal combustion engines shown in the drawings are for illustration purposes only and do not necessarily reflect what will apply in a working engine. It will also be understood that the orientation of the internal combustion engine shown in the drawings and the references to ‘up’ and ‘down’ made in the description are put forth as such by way of example and for ease of understanding and are not to be taken as limiting.

The internal combustion engine of the illustrated embodiments may be used in motor vehicles. It is presently envisaged that the engine will be particularly suitable for use on small vehicles such as motorcycles and scooters. However, the engine is not limited to such use. The engine could, for example, also be used to power boats, electricity generator sets, portable machines (for example compressors), lawn mowers and tools.

1. An internal combustion engine comprising:
a chamber,
a flexible dividing member secured in said chamber to divide said chamber into a first chamber portion having a variable volume and a second chamber portion having a variable volume,
inlet valving operable to admit constituents of a combustible mixture into said first chamber portion for combustion in said first chamber portion to provide a pressure increase to cause flexing of said flexible dividing member to reduce said volume of said second chamber portion to force a liquid from said second chamber portion as an energy output of said chamber and
input valving to admit an aqueous fluid into said first chamber portion to provide a supply of aqueous fluid in said first chamber portion to protect said flexible dividing member.

2. An internal combustion engine as claimed in claim 1, comprising a controller to control operation of said input valving so that said aqueous fluid is admitted into said first chamber portion such that said flexible dividing member is at least substantially covered by said aqueous fluid when combustion of said combustible mixture is initiated.

3. An internal combustion engine as claimed in claim 1, wherein said flexible dividing member is provided with a plurality of surface depressions to receive said aqueous fluid.

4. An internal combustion engine as claimed in claim 1, wherein said input valving is connected with an exhaust system that is connected with said first chamber portion and said aqueous fluid is supplied to said input valving from said exhaust system.

5. An internal combustion engine as claimed in claim 4, wherein said exhaust system comprises a cooling system to cool exhaust gases exhausted from said first chamber portion.

6. An internal combustion engine as claimed in claim 5, wherein said aqueous fluid is at least partially supplied from aqueous fluid condensate condensed from said exhaust gases cooled by said cooling system.

7. An internal combustion engine as claimed in claim 5, wherein said aqueous fluid is at least partially supplied from a coolant of said cooling system.

8. An internal combustion engine as claimed in claim 5, wherein said exhaust system comprises a receptacle to receive said exhaust gases, cooling of exhaust gases in said receptacle being such as to provide a vacuum in said first chamber portion.

9. An internal combustion engine as claimed in claim 8, wherein said receptacle has an outlet to release exhaust gases from said receptacle and valving to close said outlet.

10. An internal combustion engine as claimed in claim 8, wherein said receptacle has a volume greater than a maximum volume of said first chamber portion.

11. An internal combustion engine as claimed in claim 1, comprising an exhaust system having receptacle to receive exhaust gases from said first chamber portion and a cooling system to cool said exhaust gases in said receptacle to produce a pressure reduction said receptacle, said receptacle having a volume greater than a maximum volume of said first chamber portion to produce a desired level of vacuum in said first chamber portion that is proportional to a ratio of said maximum volume of said first chamber and said volume of the receptacle.

12. An internal combustion engine as claimed in claim 1, comprising an output storage device to receive said liquid forced from said second chamber portion, said output storage device being arranged such that said liquid flows into said output storage device through a region of said output storage device that is maintained free of liquid.

13. An internal combustion engine as claimed in claim 1, comprising a controller to control said inlet valving such that said combustible mixture comprises levels of fuel sufficient to promote steam reformation in said first chamber portion, said steam reformation separating hydrogen from said fuel to provide hydrogen that is combusted in said first chamber portion.

14. A method of operating an internal combustion engine that comprises a chamber that is divided into a first chamber portion and a second chamber portion by a flexible dividing member secured within said chamber, said first and second chamber portions each having a volume that is variable by flexing movement of said flexible dividing member,
said method comprising providing an aqueous liquid covering on a face of said flexible dividing member that faces into said first chamber portion, and
combusting a combustible mixture in said first chamber portion to provide a pressure increase that causes said flexible dividing member to move towards said second chamber portion to reduce said volume of said second chamber portion to force a liquid from said second chamber portion as an energy output of said chamber.

15. A method of operating an internal combustion engine as claimed in claim 14, comprising supplying said aqueous liquid from a coolant system of an exhaust system of said internal combustion engine.

16. A method of operating an internal combustion engine as claimed in claim 14, comprising providing sufficient levels of fuel in said combustible mixture to promote steam reformation of at least a portion of said fuel during combustion of said combustible mixture to separate hydrogen from said fuel that is combusted in said combustible mixture.

17. An internal combustion engine comprising:
a chamber,
a flexible dividing member secured in said chamber to divide said chamber into a first chamber portion having a variable volume and a second chamber portion having a variable volume said flexible member having a first side that partially defines said first chamber portion and a second side that partially defines said second chamber portion,
inlet valving operable to admit constituents of a combustible mixture into said first chamber portion for combustion in said first chamber portion to provide a pressure increase to cause flexing of said flexible dividing member to reduce said volume of said second chamber portion to force a liquid from said second chamber portion as an energy output of said chamber,
a container to contain a supply of a liquid comprising water,
input valving to admit said liquid comprising water from said container into said first chamber portion and
a controller operable to control said input valving such that a pool of said liquid comprising water is maintained on said first side of said flexible dividing member.

18. An internal combustion engine as claimed in claim 17, comprising at least one level sensor to detect a level of said pool and supply detection signals to said controller.

19. An internal combustion engine as claimed in claim 17, wherein said first side of said flexible dividing member is provided with surface depressions to receive said liquid comprising water.

20. A motor cycle comprising an internal combustion engine, said internal combustion engine comprising:
a housing that defines a chamber,
a flexible dividing member secured in said chamber to divide said chamber into a first chamber portion having a variable volume and a second chamber portion having a variable volume said flexible member having first side that partially defines said first chamber portion and a second side that partially defines said second chamber portion,
inlet valving operable to admit constituents of a combustible mixture into said first chamber portion for combustion in said first chamber portion to provide a pressure increase to cause flexing of said flexible dividing member to reduce said volume of said second chamber portion to force a liquid from said second chamber portion as an energy output of said chamber,
a container to contain a supply of a liquid comprising water,
input valving to admit said liquid comprising water from said container into said first chamber portion,
a controller operable to control said input valving such that a pool of said liquid comprising water is maintained on said first side of said flexible dividing member and
a drive unit to convert energy stored in said liquid forced from said second chamber into a force to drive a wheel of said motor cycle.
